(19) United States
(12) Patent Application Publication
(10) Pub. No.: US 2026/0169824 A1
(43) Pub. Date: Jun. 18, 2026

(54) OPTIMIZING COMPUTATIONAL STORAGE USE FOR THREAT DETECTION

(71) Applicant: INTERNATIONAL BUSINESS MACHINES CORPORATION, Armonk, NY (US)

(72) Inventors: Evelyn Marie Perez, Winchester (GB); Anuj Chandra, Bengaluru (IN); Imran Imtiaz, Manchester (GB); Graham Woodward, Manchester (GB)

(21) Appl. No.: 18/978,636

(22) Filed: Dec. 12, 2024

(51) Int. Cl. G06F 9/50; G06F 9/48; G06F 21/56

(52) U.S. Cl. CPC G06F 9/5083; G06F 9/4881; G06F 21/566; G06F 2221/034

(57) ABSTRACT

Optimization of use of computational storage for threat detection is provided. A storage volume associated with a first system is identified. A workload of the storage volume is forwarded to a second system via a network. The second system includes a second computing storage device configured to perform threat detection. An alert of a threat detected in the workload of the storage volume is received from the computing storage device of the second system. The workload of the storage volume on the first system is isolated.

### BACKGROUND

Embodiments of the present disclosure relate to use of computational storage, and more specifically, to optimizing use of computational storage for threat detection in a replication environment.

### BRIEF SUMMARY

According to embodiments of the present disclosure, methods of, systems of, and computer program products for optimizing use of computational storage for threat detection are provided. In some embodiments, a method of optimizing use of computational storage for threat detection is provided. The method comprises the following steps. A storage volume associated with a first system is identified. A workload of the storage volume is forwarded to a second system via a network. The second system includes a second computing storage device configured to perform threat detection. In some embodiments, threat detection of the workload of the storage volume by the second computing storage device of the second system can be enabled. In some embodiments, such enablement can be based on computing capacity of the second computing storage device and of a first computing storage device, configured to perform threat detection, of the first system. In some embodiments, the enablement can be based on load balancing between the first computing storage device and second computing storage device. In some embodiments, the enablement can be based on a utilization rate of the first computing storage device and second computing storage device. An alert of a threat detected in the workload of the storage volume is received from the computing storage device of the second system. The workload of the storage volume on the first system is isolated.

In some embodiments, a system is provided. The system comprises a computing node. The computing node comprises a computer readable storage medium having program instructions embodied therewith. The program instructions are executable by a processor of the computing node to cause the processor to perform a method. The method comprises the following steps. A storage volume associated with a first system is identified. A workload of the storage volume is forwarded to a second system via a network. The second system includes a second computing storage device configured to perform threat detection. In some embodiments, threat detection of the workload of the storage volume by the second computing storage device of the second system can be enabled. In some embodiments, such enablement can be based on computing capacity of the second computing storage device and of a first computing storage device, configured to perform threat detection, of the first system. In some embodiments, the enablement can be based on load balancing between the first computing storage device and second computing storage device. In some embodiments, the enablement can be based on a utilization rate of the first computing storage device and second computing storage device. An alert of a threat detected in the workload of the storage volume is received from the computing storage device of the second system. The workload of the storage volume on the first system is isolated.

In some embodiments, a computer program product for optimizing use of computational storage for threat detection is provided. The computer program product comprises a computer readable storage medium having program instructions embodied therewith. The program instructions are executable by a processor to cause the processor to perform a method. The method comprises the following steps. A storage volume associated with a first system is identified. A workload of the storage volume is forwarded to a second system via a network. The second system includes a second computing storage device configured to perform threat detection. In some embodiments, threat detection of the workload of the storage volume by the second computing storage device of the second system can be enabled. In some embodiments, such enablement can be based on computing capacity of the second computing storage device and of a first computing storage device, configured to perform threat detection, of the first system. In some embodiments, the enablement can be based on load balancing between the first computing storage device and second computing storage device. In some embodiments, the enablement can be based on a utilization rate of the first computing storage device and second computing storage device. An alert of a threat detected in the workload of the storage volume is received from the computing storage device of the second system. The workload of the storage volume on the first system is isolated.

### BRIEF DESCRIPTION OF THE SEVERAL VIEWS OF THE DRAWINGS

FIG. 1 is a flowchart illustrating a method according to embodiments of the present disclosure.

FIG. 2 is a schematic illustrating a method of distributing volumes across a capacity such that threat detection is split between two systems that have threat detection capabilities, according to embodiments of the present disclosure.

FIG. 3 is a schematic illustrating a method of assigning a high-priority workload from a first system without threat detection capabilities to a second system with threat detection capabilities, according to embodiments of the present disclosure.

FIG. 4 is a schematic illustrating an example of a computing node according to embodiments of the present disclosure.

### DETAILED DESCRIPTION

Computational storage is a technology where storage devices have additional compute capabilities associated with them. Computational storage, in some embodiments, provides value by offloading compute capability from a main processor or compute power onto the computational storage. Thereby, expensive data transfers are avoided and instead, computations are performed in-place. In some embodiments, this method of computation can be used for compression or deduplication operations, and can also allow for more sophisticated approaches such as entropy detection. The presence of compute capabilities on storage devices allows for operations on data which would previously be infeasible for a storage controller to perform.

As computational storage grows as a technology, ransomware attacks are also becoming more common. Such attacks may work in different ways, such as by encrypting data with a key unknown to the data owner or otherwise preventing access to data. Alternative technologies can be used to detect anomalies in workloads and indicate compromised data in a cyber-attack.

In some embodiments of the present disclosure, a “site” can include a data center having servers, power for those servers, a network connecting one or more of the servers, and storage of the servers or other devices, such that the data center can fill a business need (e.g., serving as a data center). In some embodiments, the present disclosure refers to a primary site and a secondary site. In some embodiments, a primary site can be an online/active version of a data center, and a secondary site can be a redundant or backup set of infrastructure. However, a person of ordinary skill in the art can recognize that roles of the primary and a secondary site can be interchangeable based on the application or workload, and may not be uniform across a full data center deployment.

Copy services are a collection of features which allow storage systems to have disaster recovery integrated into their Input Output (IO) path. This is achieved using replication features that transmit data to a partner storage system. The backup site performs the IO and notifies the primary site, and the IO is removed from the pending set.

Computational storage, e.g., in the form of FlashCore Modules (FCM), can be expensive. Thus, primary and secondary sites in replication environments can have different capabilities for ransomware detection using computational storage. Threat/ransomware detection features can be duplicated at both primary and secondary sites or be present only at one of the primary or secondary sites. In such examples, the threat detection capabilities can be improved in a remote copy setup to optimize resource use.

For instance, for a storage system in a replication environment having replication volumes (e.g., storage volumes), the replicated volumes can be subject to the same threat detection. This situation results in redundant scanning/usage of the threat-detecting storage tier at both ends. This redundant usage can be avoided according to some embodiments of the present disclosure.

In a replication environment, the primary and secondary systems can exchange information about threat detection capabilities according to some embodiments of the present disclosure.

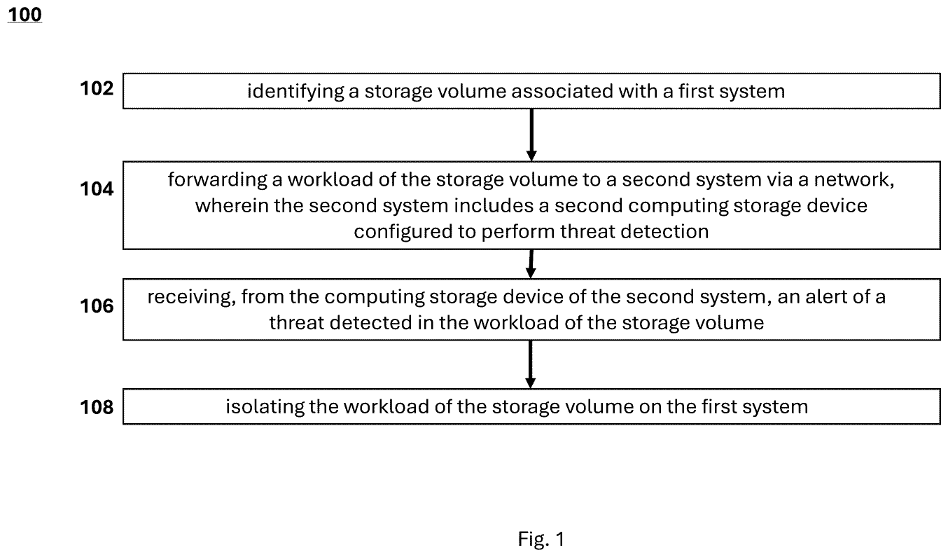

FIG. 1 is a flowchart 100 illustrating a method according to embodiments of the present disclosure. A storage volume associated with a first system is identified (102). A workload of the storage volume is forwarded to a second system via a network, wherein the second system includes a second computing storage device configured to perform threat detection (104). An alert of a threat detected in the workload of the storage volume is received from the computing storage device of the second system (106). The workload of the storage volume on the first system is isolated (108).

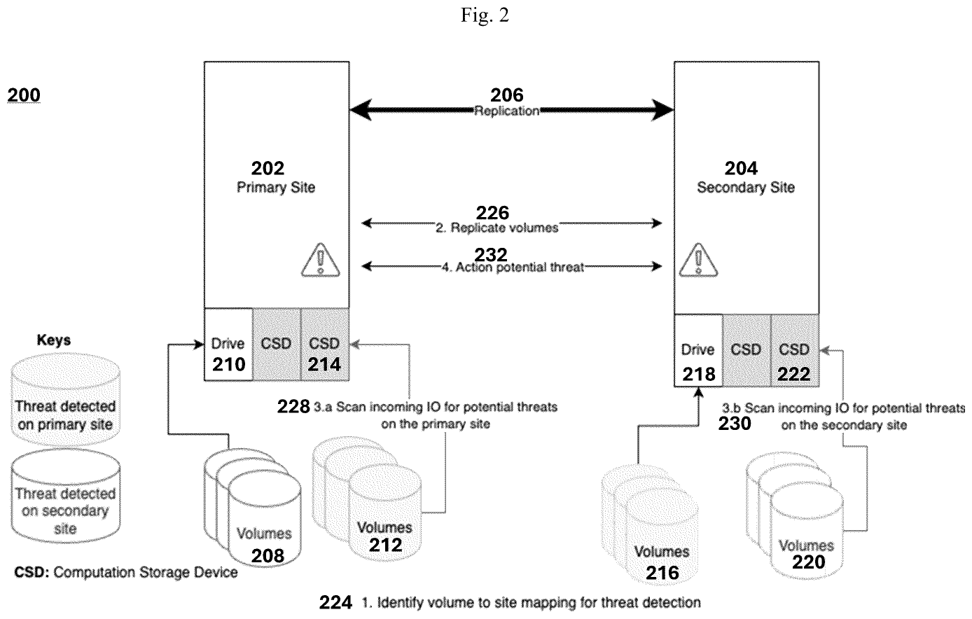

FIG. 2 is a schematic 200 illustrating volumes distributed across a capacity such that threat detection is split between two systems that have threat detection capabilities, according to embodiments of the present disclosure. Threat detection capabilities can include one or more algorithms and/or one or more metrics that are used to determine whether data has been compromised by bad actors (e.g., such as ransomware, data exfiltration, etc.). Methods for threat detection include Shannon entropy for changes in incoming data patterns and/or data access patterns, rule-based or AI analysis, etc., to classify data risk. A primary site 202 and a secondary site 204 are configured to be part of a replication environment 206. The primary site 202 includes a drive 210 that receives volumes 208 for threats detected on the secondary site. The secondary site similarly includes a drive 218 that receives volumes 216 for threats detected on the primary site. The primary site also includes one or more computation storage devices (CSDs) 214 that receive volumes 212 for threats detected on the primary site. The secondary site similarly includes one or more computation storage devices (CSDs) 222 that receive volumes 220 for threats detected on the secondary site. Both the primary and the secondary sites can be capable of threat detection, but do not have full coverage with that capacity (e.g., the ability to perform threat detection across one or more of those sites on their own). Computational storage can be an expensive feature, so the user may not place all data on a storage having this ability and may place some data on non-computational storage. It is desirable for the two sites to avoid scanning the same volumes. As such, the workload can be distributed by splitting the volumes to be scanned using a bitmapping technique, e.g., round robin or using the incoming host Input/Output (I/O) site, between the two sites (224, 226). The local threat detection can then alert the partner system when a threat is detected on a given volume (228, 230, 232) corresponding to the volume on which the threat was detected.

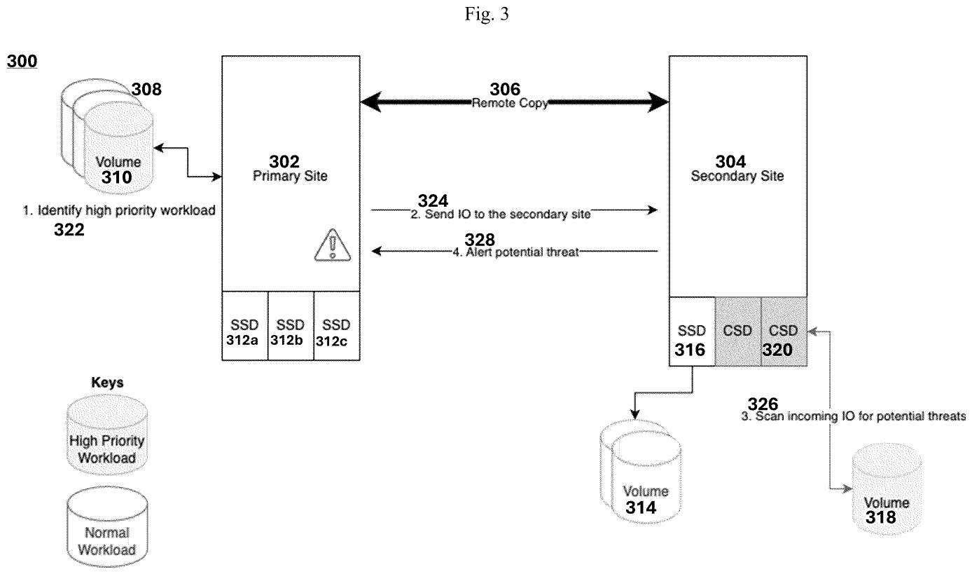

FIG. 3 is a schematic 300 illustrating a first system without threat detection capabilities assigning a high-priority workload to a threat detection tier on a second system with threat detection capabilities, according to embodiments of the present disclosure. A remote copy channel 306 connects a primary site 302 and a secondary site 304. The primary site includes one or more solid state drives (SSDs) 312. The primary site 302 does not have computational storage.

The secondary site includes a SSD 316 that outputs a normal volumes 314. In some embodiments, a normal volume 314 is a volume that does not have threat detection capabilities. The secondary site also includes one or more computation storage devices (CSDs) 320 that communicate with one or more high-priority workload volumes 318. In some embodiments, CSDs are storage devices (e.g., a server with one or more drives) that have computational capabilities, such that the CSD can offload processing from the host application or other server. In some embodiments, a CSD can be, for example, a storage enclosure with computational capabilities. While the primary site 302 does not have computational storage, the secondary site 304 includes computational storage 320 and is capable of threat detection.

The primary site 302 identifies one or more high-priority workload volumes 310 from one or more volumes 308 (322). The primary site 302 can transmit the one or more high-priority workload volumes 310 to the secondary site over the remote copy channel 306 (324). In some embodiments, a high-priority workload can be identified in response to user actions or by monitoring the number of I/Os received on a volume. For instance, a volume that sees a higher proportion of write I/O can be classified as a high-priority workload since such a volume is more likely to be affected by a ransomware attack than a volume which only gets read I/O. A migration map of a volume can factor in identifying high-priority workloads because the promotion of a workload volume to higher tiers, or conversely the demotion of a workload volume to lower tiers, indicates how actively used the workload might be. The migration map of the volume can be produced with a tiering mechanism. In some embodiments, a tiering mechanism can provide for the mixing of features, performances, or capacities within a pool of storage and a migration plan to place data or move data between those features, performances, or capacities to allow for optimal utilization of those features, performances, or capacities. The tiering mechanism, for example, can be executed by a processor to send messages and/or commands over a network connecting the pool of storage to utilize the computational storage according to a desired mix of the features, performances, or capacities. In some embodiments, threat detection can be employed as a criterion for the migration map.

Referring again to FIG. 3, the secondary site 304 promotes the one or more high-priority workload volumes 318 to the threat detecting tier (326). If a potential threat is identified, the secondary site 304 alerts the primary site 302 (328).

This scenario can be reversed if computational storage exists on the primary site 302 and not on the secondary site 304. As an extension, if a system starts out without computational storage, threat detection capability can be added to the system using an additional threat detection disaster recovery secondary site.

According to some embodiments of the present disclosure, a storage subsystem identifies a tier to leverage the threat detection properties of two systems. The storage subsystem makes available tiers of storage/capabilities. The storage subsystem is aware of those tiers of storage/capabilities that are available. In some embodiments, to balance capabilities across two sites (e.g., a primary and secondary site) employs knowledge of the storage system at each site in terms of its capabilities, sharing of this knowledge between the storage at both sites, and coordinated data placement across both sites to optimize the threat detection capabilities to maximize coverage. Therefore, a storage subsystem can send a message indicating the storage/capabilities that it has available so that an entire pool of storage subsystems can balance computational load across a plurality of tasks. The configuration of threat-detecting storage can be optimized across the systems to avoid duplicate attempts to detect threats in both systems and rebalance the workload. Additionally, threat detection capabilities of the secondary site can be leveraged in the absence of storage with threat detection capabilities at the primary site.

In alternative systems, threat detection hardware in the form of computation storage (e.g., Flash Core Modules or FCMs in IBM Flashsystem) is configured for use in a single storage cluster. According to some embodiments of the present disclosure, where threats are evident, the capacity from the computational (e.g., threat-detecting) storage can be configured as a home tier where all the incoming data to the storage system is initially received. In case of threats being detected, the data where potential ransomware attacks are detected can be subject to policy-based handling, such as isolating the data or flagging the data source.

In a replication environment, according to some embodiments of the present disclosure, a response to a potential threat can be configured to stop the propagation of the potential threat. The remedial actions can be taken automatically, based on a policy, proactively, or manually. The policy can associate a remedial action with alert information or another trigger condition. The remedial actions can be configured by the operator. The system can use alert information as a trigger to proactively stop replication on the affected workloads. If more granular information (e.g., information referring to portions of the storage such as logical block addresses or segments of the overall volume) about the threat is sent/received in additional metadata with the alert, then multiple copies of the data can be stored (e.g., in quarantine) for the operator to then inspect and take further mitigation steps based on, such as isolating the affected workloads.

Some embodiments of the present disclosure can be applied to any technology that provides multiple copies, snapshots, or replicas of a volume.

There are numerous benefits of sharing threat-detecting capabilities across clusters in a replication environment according to some embodiments of the present disclosure. For instance, some embodiments of the present disclosure provide a mechanism for systems that do not have threat detection capabilities to be protected by threat detection by leveraging threat detection hardware present in another system (e.g., a system that the current system is replicating to or from).

Additionally, if the threat detection capacity on a primary system is oversubscribed, some embodiments of the present disclosure allow the system to make efficient use of resources by sharing or distributing threat detection capabilities with another system. Such sharing or distribution enables the optimal usage of computational storage/threat detecting hardware in replication environments.

In cases where a primary site and a secondary site both have threat-detecting capabilities, according to some embodiments of the present disclosure, one of the sites alone, such as the primary site, can be configured to use threat-detecting storage. This frees up the threat-detecting storage at the secondary site to be used for detecting threats where the secondary system is the point of ingress. Such a strategy prevents duplicate/redundant use of expensive threat-detecting resources for the same data set and allows the storage to handle more workloads.

In alternative methods, both systems in a replication environment may try to perform threat detection on replicated data sets. This strategy prevents the use of threat-detecting hardware for other workloads which could have benefitted from such capabilities. Also, in alternative methods, every system needs threat-detecting storage, which is costly, in order to detect ransomware attacks.

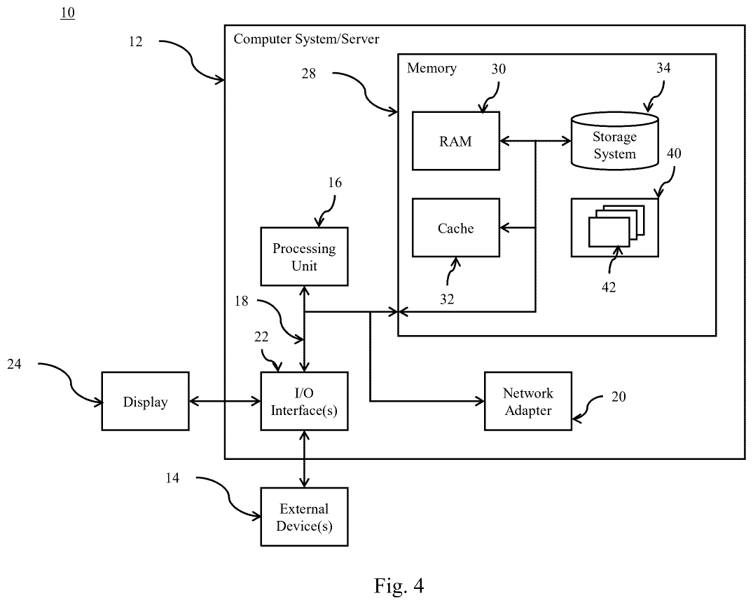

FIG. 4 is a schematic illustrating an example of a computing node according to embodiments of the present disclosure. Computing node 10 is only one example of a suitable computing node and is not intended to suggest any limitation as to the scope of use or functionality of embodiments described herein. Regardless, computing node 10 is capable of being implemented and/or performing any of the functionality set forth hereinabove.

In computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 4, computer system/server 12 in computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus, Peripheral Component Interconnect Express (PCIe), and Advanced Microcontroller Bus Architecture (AMBA).

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the disclosure.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments as described herein.

Computer system/server 12 may also communicate with one or more external devices 14 such as a keyboard, a pointing device, a display 24, etc. ; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

The present disclosure may be embodied as a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
identifying a storage volume associated with a first system;
forwarding a workload of the storage volume to a second system via a network, wherein the second system includes a second computing storage device configured to perform threat detection;
receiving, from the computing storage device of the second system, an alert of a threat detected in the workload of the storage volume; and
isolating the workload of the storage volume on the first system.

2. The method of claim 1, further comprising: distributing a plurality of volumes across the first system and the second system using a bitmapping technique.

3. The method of claim 1, wherein the workload is assigned to a threat detection tier on the second system.

4. The method of claim 1, wherein the workload is a high-priority workload.

5. The method of claim wherein the workload is identified as high-priority based on one or more of the following:
user actions; or
monitoring the number of Input/Outputs received on a volume; or
monitoring the number of write Input/Outputs received on a volume; or
monitoring the number of read Input/Outputs received on a volume; or
a volume migration map produced using a tiering mechanism.

6. The method of claim 1, further comprising one or both of the following in response to the alert:
sending the alert from the second system to the first system; or
subjecting data affected by the threat to policy-based handling.

7. The method of claim 1, wherein the first system includes a first computing storage device configured to perform threat detection, the method further comprising:
replicating the storage volume of the first system at the second system as a replicated storage volume; and
disabling, at the first system, threat detection of the storage volume by the first computing storage device of the first system;
wherein the alert represents a threat detected in the replicated storage volume by the second computing storage device.

8. The method of claim 7, wherein disabling threat detection of the storage volume by the first computing storage device of the first system is based on one or more of the following:
computing capacity of the first computing storage device and second computing storage device;
load balancing between the first computing storage device and second computing storage device, and
a utilization rate of the first computing storage device and second computing storage device.

9. The method of claim 6, wherein the policy-based handling of the affected data comprises one or more of the following:
isolating the data; or
stopping replication on the data; or
flagging a source of the data.

10. A system comprising:
a computing node comprising a computer readable storage medium having program instructions embodied therewith, the program instructions executable by a processor of the computing node to cause the processor to perform a method comprising:
identifying a storage volume associated with a first system;
forwarding a workload of the storage volume to a second system via a network, wherein the second system includes a second computing storage device configured to perform threat detection;
receiving, from the computing storage device of the second system, an alert of a threat detected in the workload of the storage volume; and
isolating the workload of the storage volume on the first system.

11. The system of claim 10, wherein the processor-executable instructions, when executed by the processor, further cause the processor to distribute a plurality of volumes across the first system and the second system using a bitmapping technique.

12. The system of claim 10, wherein the workload is assigned to a threat detection tier on the second system.

13. The system of claim 10, wherein the workload is a high-priority workload.

14. The system of claim 13, wherein the workload is identified as high-priority based on one or more of the following:
user actions; or
monitoring the number of Input/Outputs received on a volume; or
monitoring the number of write Input/Outputs received on a volume; or
monitoring the number of read Input/Outputs received on a volume; or
a volume migration map produced using a tiering mechanism.

15. The system of claim 10, wherein the processor-executable instructions, when executed by the processor, further cause the processor to do one or both of the following in response to the alert:
send the alert from the second system to the first system; or
subject data affected by the threat to policy-based handling.

16. The system of claim 10, wherein the first system includes a first computing storage device configured to perform threat detection, and wherein the processor-executable instructions, when executed by the processor, further cause the processor to:
replicate the storage volume of the first system at the second system as a replicated storage volume; and
disable, at the first system, threat detection of the storage volume by the first computing storage device of the first system;
wherein the alert represents a threat detected in the replicated storage volume by the second computing storage device.

17. The system of claim 16, wherein disabling threat detection of the storage volume by the first computing storage device of the first system is based on one or more of the following:
computing capacity of the first computing storage device and second computing storage device;
load balancing between the first computing storage device and second computing storage device; and
a utilization rate of the first computing storage device and second computing storage device.

18. The system of claim 15, wherein the policy-based handling of the affected data comprises one or more of the following:
isolating the data; or
stopping replication on the data; or
flagging a source of the data.

19. A computer program product for optimizing use of computational storage for threat detection, the computer program product comprising a computer readable storage medium having program instructions embodied therewith, the program instructions executable by a processor to cause the processor to perform a method comprising:
identifying a storage volume associated with a first system;
forwarding a workload of the storage volume to a second system via a network, wherein the second system includes a second computing storage device configured to perform threat detection;
receiving, from the computing storage device of the second system, an alert of a threat detected in the workload of the storage volume; and
isolating the workload of the storage volume on the first system.

20. The computer program product of claim 19, wherein the processor-executable instructions, when executed by the processor, further cause the processor to distribute a plurality of volumes across the first system and the second system using a bitmapping technique.
